(19) United States
(12) Patent Application Publication
(10) Pub. No.: US 2008/0253806 A1
(43) Pub. Date: Oct. 16, 2008

(54) GRID ELECTRODE, SCOROTRON CHARGER, AND PROCESS CARTRIDGE, AND IMAGE FORMING APPARATUS INCORPORATING SAME

(76) Inventors: Kaoru YOSHINO, Tokyo (JP); Takaya Muraishi, Kawasaki-shi (JP); Akio Kosuge, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/099,496

(22) Filed: Apr. 8, 2008

(30) Foreign Application Priority Data
Apr. 13, 2007 (JP) 2007-106122

(51) Int. Cl. G03G 15/02

(52) U.S. Cl. 399/171

(57) ABSTRACT

A grid electrode disposed across from a charge wire includes a planar member and a plurality of linear pattern wires. The planar member includes a plurality of adjacent, aligned openings, each having a long side and a short side. The pattern wires extend in the long direction of the openings, and are evenly spaced in the short direction of the openings. A process cartridge detachable from an image forming apparatus includes an image carrier to bear a toner image and a scorotron charger for charging the image carrier. The scorotron charger includes a shield case, a charge wire tensioned in a long direction of the shield case, and the grid electrode. An image forming apparatus includes the grid electrode and the process cartridge.

### CROSS-REFERENCE TO RELATED APPLICATIONS

This patent application is based on and claims priority pursuant to 35 U.S.C. §119 from Japanese Patent Application No. 2007-106122 filed on Apr. 13, 2007, in the Japan Patent Office, the entire contents of which are hereby incorporated herein by reference.

### BACKGROUND OF THE INVENTION

1. Field of the Invention

Exemplary aspects of the present invention generally relate to a grid electrode, a scorotron charger, a process cartridge, and an image forming apparatus incorporating the same.

2. Description of the Background Art

In the field of charging devices for charging a surface of a photoreceptor (an image carrier) used in image forming apparatuses using an electrophotographic technique, such as a copier, a laser printer, and the like, a scorotron charger is known. The known scorotron charger generally includes a charge wire and a grid electrode. The charge wire is disposed within a shield case a certain distance from the surface of the photoreceptor. The grid electrode has a planar shape and a pattern of openings. and is disposed at a position closer to the photoreceptor than the charge wire.

When the charge wire is supplied with a high voltage, corona discharge is generated so that the surface of the photoreceptor can be charged with the same potential as that of the grid electrode. Japanese Patent Laid-Open Application Publication No. 2005-338797 discloses an example of evenly charging the photoreceptor surface and regulating the potential of the photoreceptor.

In order to optimize control of the potential of the photoreceptor, it is preferable that a pitch of the opening pattern along a direction of movement of the photoreceptor be uniform. When the pitch of the opening pattern is uniform, control of the grid electrode can be enhanced, thus suppressing bright spot discharge which may cause irregular image density.

As disclosed in Japanese Patent Laid-Open Application Publication No. 2005-338797, the opening pattern has a plurality of openings, each of which has a long and narrow hexagonal shape. The openings are arranged in a staggered manner forming a net-like or a honeycomb-like structure. Accordingly, uniform spacing between the openings of the opening pattern is maintained, as is mechanical strength of the grid electrode.

In an attempt to prevent deterioration of charging ability caused by contamination of the electrode with discharge products, a cleaning member, typically a brush, is provided to clean the electrode. The cleaning member is made to move in a direction orthogonal to a direction of movement of the photoreceptor (a longitudinal direction of the charge wire). Such an opening pattern as described above is implemented so as to prevent deterioration of mechanical strength caused by contact resistance with the cleaning member.

In addition, Japanese Patent Laid-Open Application Publication No. 2005-338797 proposes that corner portions of the openings are arc-shaped in order to prevent bristles of a brush serving as the cleaning member from being caught and severed by the opening corners. Such prevention is important because image failure may occur when the brush sheds bristles.

In such a structure, the cleaning member does not necessarily get caught by the opening corner portions and fall off. However, a portion of the grid pattern has a structure that comes across the cleaning member in a direction orthogonal to the direction of movement of the cleaning member, so that there is a possibility that the portion thereof may get caught on the brush (or vice-versa), and the cleaning member may not be able to contact the electrode evenly. Consequently, with repeated cleaning the potential of the photoreceptor may be reduced at a place where cleaning was not properly performed, causing image defects at this place.

To counteract this tendency, generally, the charger is replaced after a certain number of prints is made. It is economically and environmentally important to prevent irregular cleaning and cleaning failure with respect to the grid electrode while uniformity of charging ability is maintained and the product life of the charger is prolonged.

In addition, in order to further enhance control of the potential of the photoreceptor, it is desirable that the space between the photoreceptor and the grid electrode be uniform throughout an area in a short direction of the grid electrode.

When the photoreceptor is in the form of a flat belt, the structure of the grid electrode having long, narrow hexagonal openings, rectangle openings, or openings with four arc-shaped opening corner portions in the related art, for example, does not cause a significant problem. However, in general, most photoreceptors have a drum shape. Thus, when the grid electrode has a structure such as that disclosed above, it is difficult to arrange the grid electrode to follow curvature of the drum-shape photoreceptor.

The grid electrode is generally tensioned from both end portions in the longitudinal direction. When the opening pattern includes a plurality of hexagonal shapes, the tension is not evenly distributed at the center of the grid electrode. Consequently, the grid electrode cannot be arranged in a curved manner.

In the event that the grid electrode cannot be arranged in accordance with the curvature of the photoreceptor, the grid electrode is disposed in a planar manner as illustrated in FIG. 1A. However, the portion of the grid electrode in the closest contact with the photoreceptor is the center portion of the grid electrode in the short direction thereof, with the end portions of the grid electrode in the short direction more distant from the center portion. Consequently, potential control at both ends of the grid electrode deteriorates significantly.

On the other hand, when the grid electrode is disposed along the curvature of the photoreceptor, as illustrated in FIG. 1B, the space between the grid electrode and the photoreceptor is uniform.

As disclosed in Japanese Patent Laid-Open Application Publication No. 2000-330361, the grid electrode is disposed in accordance with the curvature of the photoreceptor drum. However, no optimum pattern to facilitate potential control and prevent charge irregularity is disclosed.

Japanese Patent Examined Application Publication No. Sho 61-24710 discloses a method of forming a grid electrode. In this method, a conductive wire is wound around a cylindrical member. An outer surface of the cylindrical member has grooves filled with resin, and both ends of the conductive wire are fixed with the resin, thereby forming a grid electrode.

In this method, however, it is necessary to wind the conductive wire at equal intervals, and thus the productivity is not efficient. In addition, it is difficult to dispose the grid electrode formed in such a manner along the curvature of the photoreceptor drum.

### SUMMARY OF THE INVENTION

In view of the foregoing, exemplary embodiments of the present invention provide a grid electrode capable of effectively controlling its potential and cleanable by a cleaner.

In one exemplary embodiment, the grid electrode may be disposed across from a charge wire. The grid electrode may include at least a planar member and a plurality of pattern wires. The planar member may include at least a plurality of openings aligned next to each other, each having a long side and a short side. The plurality of pattern wires may be linearly formed in the long direction of the openings, and evenly spaced in the short direction of the openings.

Another exemplary embodiment provides a process cartridge detachable from an image forming apparatus. The process cartridge may include at least an image carrier and a scorotron charger. The image carrier may include a surface that bears an electrostatic latent image. The scorotron charger is configured to charge the image carrier, and may include at least a shield case, a charge wire tensioned in a long direction of the shield case, and a grid electrode.

The grid electrode may include at least a planar member and a plurality of pattern wires. The planar member may include a plurality of openings aligned next to each other, each having a long side and a short side. The plurality of pattern wires may be linearly formed in the long direction of the openings, and evenly spaced in the short direction. The scorotron charger may be integrally provided with the photoreceptor.

Yet another exemplary embodiment provides an image forming apparatus. The image forming apparatus may include at least: an image carrier, an exposure unit, a developing unit, a transfer unit, and a scorotron charger. The image carrier includes a surface that bears an electrostatic latent image. The exposure unit is configured to irradiate the surface of the image carrier so as to form the electrostatic latent image thereon. The developing unit is configured to develop the electrostatic latent image on a surface of the image carrier so as to form a visible image. The transfer unit is configured to transfer the visible image onto a recording medium directly or indirectly through an intermediate transfer medium. The scorotron charger is configured to charge the image carrier, and may include at least a shield case, a charge wire tensioned in a long direction of the shield case, and a grid electrode. The grid electrode may include at least a planar member and a plurality of pattern wires. The planar member may include a plurality of openings aligned next to each other, each having a long side and a short side. The plurality of pattern wires may be linearly formed in the long direction of the openings, and evenly spaced in the short direction.

Additional features and advantages of the present invention will be more fully apparent from the following detailed description of exemplary embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of exemplary embodiments when considered in connection with the accompanying drawings, wherein:

FIG. 1A is a schematic diagram illustrating a spatial relation between a grid electrode and a photoreceptor when the grid electrode is in a planar shape;

FIG. 1B is a schematic diagram illustrating a spatial relation between a grid electrode and a photoreceptor when the grid electrode is in a curved shape;

FIG. 2 is a schematic diagram illustrating an image forming apparatus, according to an exemplary embodiment;

FIG. 3 is a cross-sectional view illustrating a process cartridge used in the image forming apparatus of FIG. 2, according to an exemplary embodiment;

FIG. 4 is a perspective view illustrating a scorotron charger, according to an exemplary embodiment;

FIG. 5 is a perspective view illustrating the scorotron charger of FIG. 4 when turned over, according to an exemplary embodiment;

FIG. 6A is a plane view illustrating the relative dimensions of an opening of a grid electrode and a pattern wire, according to an exemplary embodiment;

FIG. 6B is a cross-sectional view illustrating the opening and the pattern wire in a direction orthogonal to a longitudinal direction of a charge wire, according to an exemplary embodiment; and

FIG. 7 is a table showing experimental results of the grid electrode of FIG. 6, according to an exemplary embodiment.

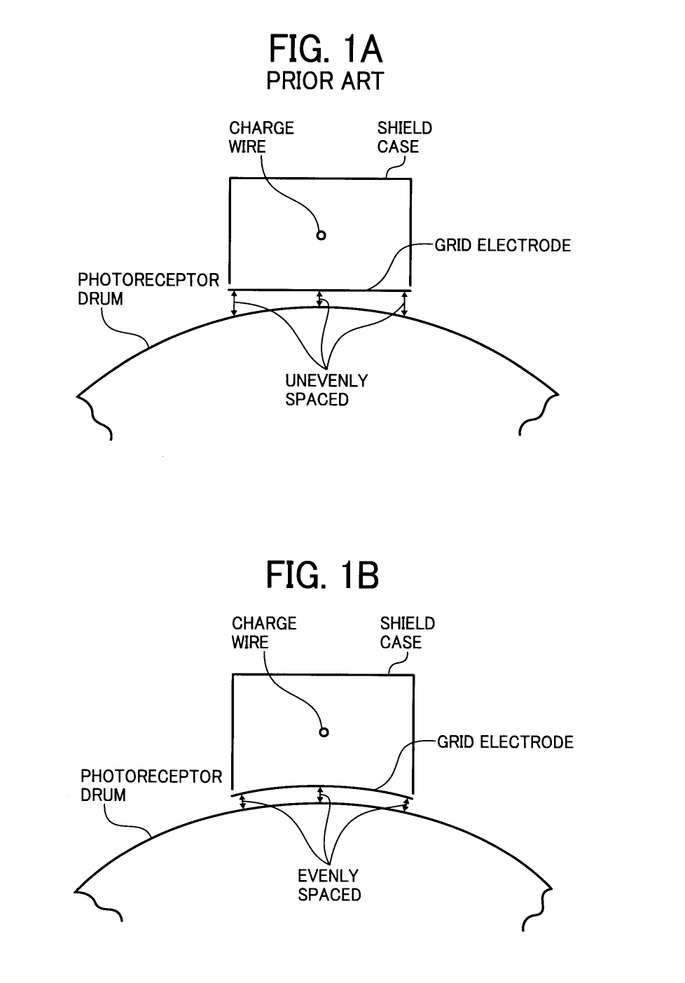

### DETAILED DESCRIPTION OF EXEMPLARY EMBODIMENTS

Exemplary embodiments of the present invention are now described below with reference to the accompanying drawings.

It will be understood that if an element or layer is referred to as being “on,” “against,” “connected to” or “coupled to” another element or layer, then it can be directly on, against connected or coupled to the other element or layer, or intervening elements or layers may be present.

In contrast, if an element is referred to as being “directly on,” “directly connected to” or “directly coupled to” another element or layer, then there are no intervening elements or layers present. Like numbers refer to like elements throughout figures. As used herein, the term “and/or” includes any and all combinations of one or more of the associated listed items.

Spatially relative terms, such as “beneath,” “below,” “lower,” “above,” “upper” and the like, may be used herein for ease of description to describe an element or an element's feature or relationship to another element(s) or feature(s) as illustrated in the figures.

It will be understood that the spatially relative terms are intended to encompass different orientations of the device in use or operation in addition to the orientation depicted in the figures.

For example, if the device in the figures is turned over, elements described as “below” or “beneath” other elements or features would then be oriented “above” the other elements or features. Thus, the term such as “below” can encompass both an orientation of above and below.

The device may be otherwise oriented at various angles (i.e. rotated 90 degrees or at other orientations), and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms.

These terms are used only to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

In a later-described comparative example, exemplary embodiment, and alternative example, for the sake of simplicity of drawings and descriptions, the same reference numerals are given to constituent elements such as parts and materials having the same functions, and redundant descriptions thereof are omitted unless otherwise stated.

Typically, but not necessarily, paper is the medium from which is made a sheet on which an image is to be formed. It should be noted, however, that other printable media are available in sheet, and accordingly their use here is included. Thus, solely for simplicity, although this Detailed Description section refers to paper, sheets thereof, paper feeder, etc., it should be understood that the sheets, etc., are not limited only to paper, but includes other printable media as well.

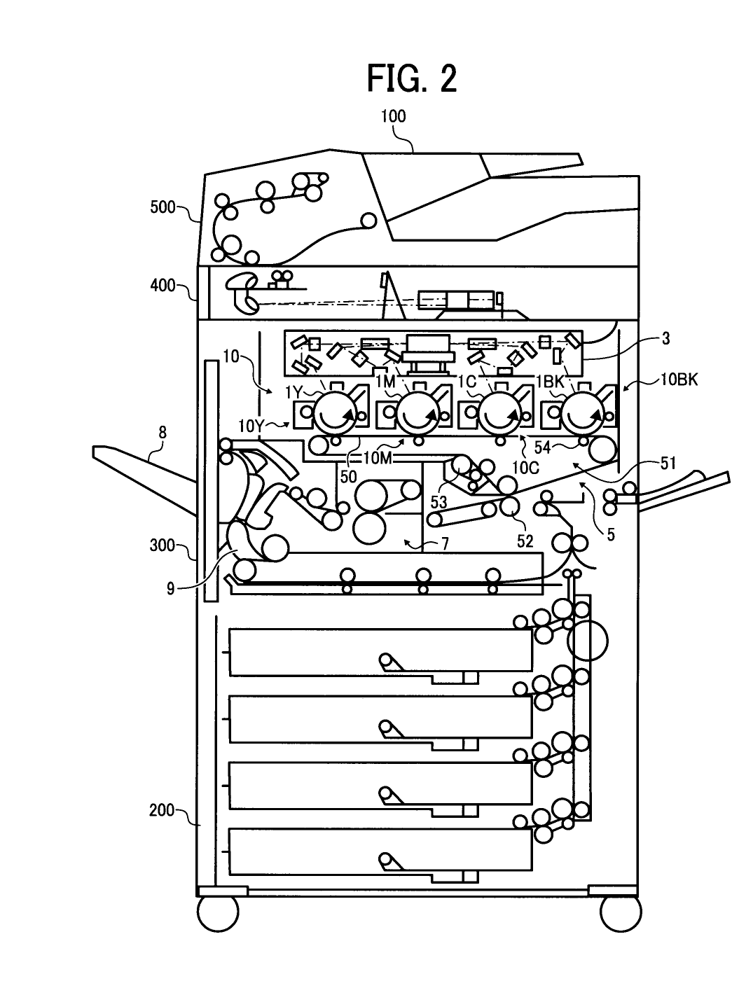

Referring now to the drawings, wherein like reference numerals designate identical or corresponding parts throughout the several views, and initially to FIG. 2, one example of an image forming apparatus such as a full-color copier which forms a color image according to an exemplary embodiment of the present invention is described.

In FIG. 2, there is provided a schematic diagram illustrating an image forming apparatus 100, for example, a full-color copier according to the exemplary embodiment.

The image forming apparatus 100 includes at least: an image forming unit 300, a sheet feeding unit 200, a document reading unit 400, and a document conveyance unit 500. The image forming unit 300 includes at least an image forming device 10, an exposure unit 3, a transfer unit 5, and a fixing unit 7.

The image forming device 10 includes process cartridges 10Y, 10C, 10M, and 10BK of different colors: yellow (Y), cyan (C), magenta (M), and black (BK), respectively. Letter symbols Y, C, M, and BK denote colors of yellow, cyan, magenta, and black, respectively. The process cartridges 10Y, 10C, 10M, and 10BK are aligned next to each other in the image forming device 10. In the center of each of the process cartridges are provided photoreceptors 1Y, 1C, 1M, and 1BK, serving as image carriers respectively. Surrounding each of the photoreceptors 1Y, 1C, 1M, and 1BK there are provided a charger 2, a developing unit 4 and a cleaning unit 6.

The exposure unit 3 converts data read by the document reading unit 400 or an image signal transmitted from a personal computer (PC), not shown, into a laser beam. A polygon motor deflects the laser beam so that it scans the photoreceptor 1. Based on the image signal read through mirrors, an electrostatic latent image is formed on the photoreceptor 1.

The transfer unit 5 includes an intermediate transfer belt 50 which travels in an endless loop. The intermediate transfer belt 50 bears toner images of different colors formed on each of the respective photoreceptors 1Y, 1C, 1M, and 1BK in an overlapping manner. The color toner images formed on the intermediate transfer belt 50 are transferred onto a recording sheet.

The intermediate transfer belt 50 is formed of multiple layers. A base layer includes a material not easily stretched, such as a fluororesin and canvas, or the like. An elastic layer is provided on the base layer. The elastic layer includes a material, for example, a fluoro-rubber and an acrylonitrile-butadiene copolymer rubber, or the like. A surface of the elastic layer is coated with a smooth coating layer including a fluororesin, for example.

The intermediate transfer belt 50 spans a plurality of support rollers and transports the color toner image while rotating in a clockwise direction. An intermediate transfer belt cleaner 53 is provided to remove toner remaining on the intermediate transfer belt 50 after the image is transferred. The toner remaining on the intermediate transfer belt 50 is referred to as toner residue.

It should be noted, however, that the structure for transferring the toner images is not limited to the structure described above. Thus, alternatively, for example, the toner images formed on each of the photoreceptors 1Y, 1C, 1M, and 1BK may be transferred directly onto a recording sheet transported by a transfer conveyance belt.

A primary transfer device 54 is disposed across from each of the photoreceptors 1Y, 1C, 1M, and 1BK. The primary transfer device 54 according to the exemplary embodiment is a roller. The intermediate transfer belt 50 is nipped between the primary transfer roller 54 and the photoreceptors 1Y through 1BK. The primary transfer roller 54 is connected to a power source, not shown, and a voltage is applied to the primary transfer roller 54 when the toner images on the photoreceptors 1Y through 1BK are transferred to the intermediate transfer belt 50. Accordingly, an electric field is formed between the photoreceptor 1 and the intermediate transfer belt 50 and the toner images are electrostatically transferred to the intermediate transfer belt 50.

A secondary transfer device 52 is disposed nipping the intermediate transfer belt 50. The secondary transfer device 52 according to the exemplary embodiment is a roller. Adjacent to the secondary transfer roller 52 is provided a fixing unit 7 for fixing the transfer image on the recording sheet.

The fixing unit 7 includes a pressure roller and a belt stretchedly supported by a roller equipped with a halogen heater and so forth inside. The pressure roller and the belt form a nip. In the nip, heat and pressure are applied to the toner on the recording sheet so that the toner image is fixed.

Alternatively, a pair of rollers or a pair of belts may be used in the fixing unit 7. The image forming apparatus 100 may also include a reverse unit 9, a discharge tray 8, and so forth.

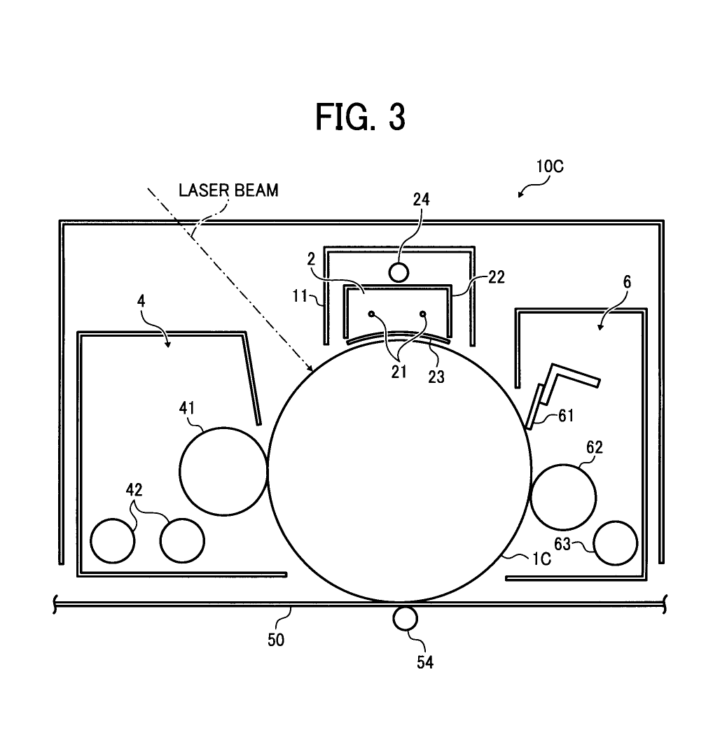

Referring now to FIG. 3, there is provided an enlarged view illustrating the process cartridge 10C of FIG. 2. A description is given of the process cartridge 10C as a representative example of the process cartridge. The structure of other process cartridges 10Y, 10M, and 10BK is similar to, if not the same as that of the process cartridge 10C. Thus, the description thereof is omitted herein unless otherwise stated.

As illustrated in FIG. 3, the process cartridge 10C may include the photoreceptor 1C, the charger 2, the developing unit 4, the cleaning unit 6, a charge cleaner 24, an exhaust duct 11, and so forth.

The photoreceptor 1C may include an amorphous metal such as amorphous silicon, amorphous selenium, and the like, or organic compounds such as bisazo pigment, phthalocyanine pigment, and the like. Due to environmental concerns and post-processing after use, it is preferable to use the organic compounds.

The charger 2 is a scorotron charger (hereinafter referred to as a scorotron charger 2), and includes a charge wire 21, a shield case 22, a grid electrode 23, and a power source, not shown, connected to each of the charge wire 21 and the grid electrode 23. High voltage is applied to the charge wire 21 and the grid electrode 23 so that corona discharge occurs between the photoreceptor 1 and the charge wire 21 and the surface of the photoreceptor 1 is evenly charged.

The grid electrode 23 is disposed along the curvature of the photoreceptor 1 so as to optimize control of the potential. The charge cleaner 24 is provided in order to maintain stable charging ability over time.

An exhaust duct 11 communicates with a back of the image forming apparatus 100 to discharge exhaust air to the outside of the image forming apparatus 100 through an ozone filter.

The developing unit 4 may include at least a developer carrier 41 and a toner supply screw 42. The developer carrier 41 bears and supplies the developer to the photoreceptor 1C. The developer carrier 41 has a hollow cylindrical shape and is rotatable. Inside thereof is provided a magnet roll fixed to the same shaft that supports the developer carrier 41. The developer is magnetically attracted to a peripheral surface of the developer carrier 41 and transported.

The developer carrier 41 includes conductive and nonmagnetic material. A power source, not shown, for applying a developing bias is connected to the developer carrier 41. When a voltage is applied across the space between the developer carrier 41 and the photoreceptor 1, an electric field is formed in the developing region.

The cleaning unit 6 may include at least a cleaning blade 61, a brush roller 62, a waste toner discharge screw 63 and so forth. The cleaning unit 6 removes the toner residue remaining on the photoreceptor 1C after the primary transfer process is performed so as to prepare for the subsequent image forming process.

The scorotron charger 2, the developing unit 4, the cleaning unit 6 and the photoreceptor 1C may together constitute the process cartridge 10C. The process cartridge 10C is configured to be detachably mountable relative to the image forming apparatus 100.

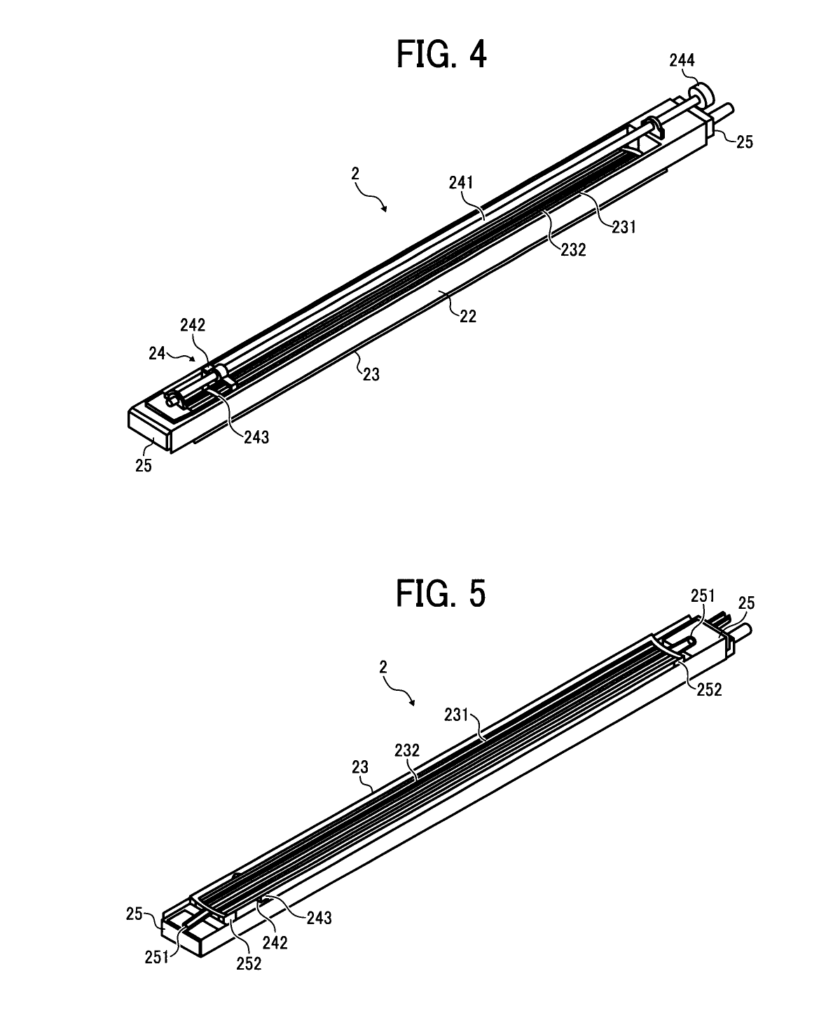

A detailed description is now given of the scorotron charger 2, with reference to FIG. 4 and FIG. 5. FIG. 4 is a perspective view illustrating the scorotron charger 2. FIG. 5 is a perspective view illustrating the scorotron charger 2 when the scorotron charger 2 of FIG. 4 is turned over.

As illustrated in FIG. 4, end blocks 25 formed of an insulating resin are each fixed at front and rear ends of the shield case 22. The charge wire 21 and the grid electrode 23 are secured to the end blocks 25.

As illustrated in FIG. 5, the end blocks 25 each include a hook 251 and a curve forming member 252. The grid electrode 23 is tensioned by the hooks 251 at both ends. Because the grid electrode 23 is formed of a relatively thin, elastically deformable planar member, the grid electrode 23 can be deformed to conform to the curved shape of the curve forming members 252. Accordingly, the grid electrode 23 is tensioned in a curved manner.

According to the exemplary embodiment, the grid electrode 23 is disposed at a position approximately 2 mm distant from the photoreceptor 1. The grid electrode 23 may include a plurality of openings 231 and a plurality of pattern wires 232.

The pattern wires 232 are formed in a longitudinal direction of the openings 231. In other words, the plurality of pattern wires 232 is formed on the thin plate through a pattern process, thereby dividing each of the plurality of the openings 231.

The pattern wires 232 are evenly spaced in the short direction. The pattern wires 232 according to the exemplary embodiment may be formed on a relatively thin planar member made of a stainless steel, for example SUS 304, or the like. Through the pattern process, the plurality of the pattern wires 232 is formed in a linearly extending manner in the longitudinal direction of the openings 231. The pattern method used when forming the pattern wires 232 may be an etching process, for example.

A description will now be given of the charge cleaner 24, with reference to FIG. 4 and FIG. 5.

As illustrated in FIG. 4, the charge cleaner 24 may include a feed screw 241, a sliding member 242, a cleaning pad 243 serving as a cleaning member, and a drive gear 244. When the feed screw 241 is rotatively driven by the drive gear 244, the sliding member 242 travels back and forth, enabling the cleaning pad 243 to clean the grid electrode.

The openings 231 and the pattern wires 232 do not have a structure that could interfere with the cleaning pad 243 and prevent it from traveling. In other words, the openings 231 and the pattern wires 232 do not have something that may cause the cleaning pad 243 to get caught. Accordingly, irregular cleaning and cleaning failure are reduced, if not prevented entirely. Furthermore, because the pattern wires 232 linearly extend in a direction of travel of the cleaning pad 243, the cleaning pad 243 can travel back and forth along its direction of travel without getting caught by the openings 231 and/or the pattern wires 232. Accordingly, during the traveling movement, a constant slide resistance can be achieved.

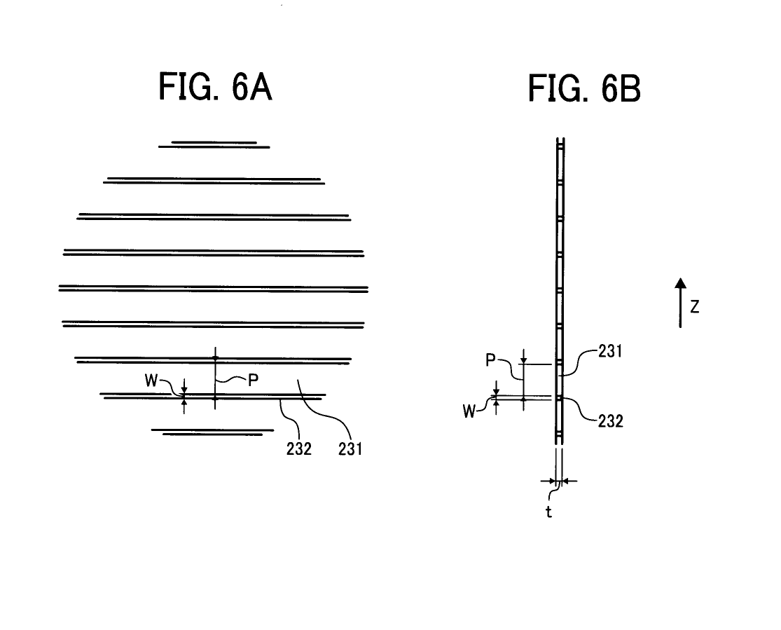

A description will now be given of the openings 231 of the grid electrode 23, with reference to FIG. 6A and FIG. 6B.

FIGS. 6A and 6B illustrate the relative dimensions of the openings 231 and the pattern wires 232. In FIG. 6B, an arrow Z indicates a direction of rotation of the photoreceptor. As described above, the grid electrode 23 includes a plurality of the openings 231. The pattern wires 232 are formed in the longitudinal direction. The pattern wires 232 are evenly spaced in the short direction. The pitch between the pattern wires 232 is denoted as P. Accordingly, control of the potential is enhanced.

In order to tension the grid electrode 23 along the curvature as illustrated in FIG. 5, it is desirable to configure a wire width W of the pattern wires 232 to be less than or equal to the plate thickness t of the grid electrode 23. According to the exemplary embodiment, the wire width W is configured to be 0.1 mm, and the plate thickness is configured to be 0.1 mm for the sake of mechanical strength.

When an opening ratio of the grid electrode 23 is set to 80% to 87.5%, potential control is enhanced, and irregular image concentration caused by irregular charging does not occur. The opening ratio of the grid electrode 23 herein refers to a ratio of the openings 231 of the grid electrode 23 facing the photoreceptor 1 to the entire surface area of the grid electrode 23 including the pattern wires 232, as calculated by the following equation: ({P/(P+W)}×100[%]).

However, when the opening ratio is significantly large, the grid electrode 23 is unable to suppress the effect of bright spot discharge of the charge wire 21. Consequently, the photoreceptor is not evenly charged. On the other hand, when the opening ratio is significantly small, a potential difference between the potential of the photoreceptor and the grid electrode is too large.

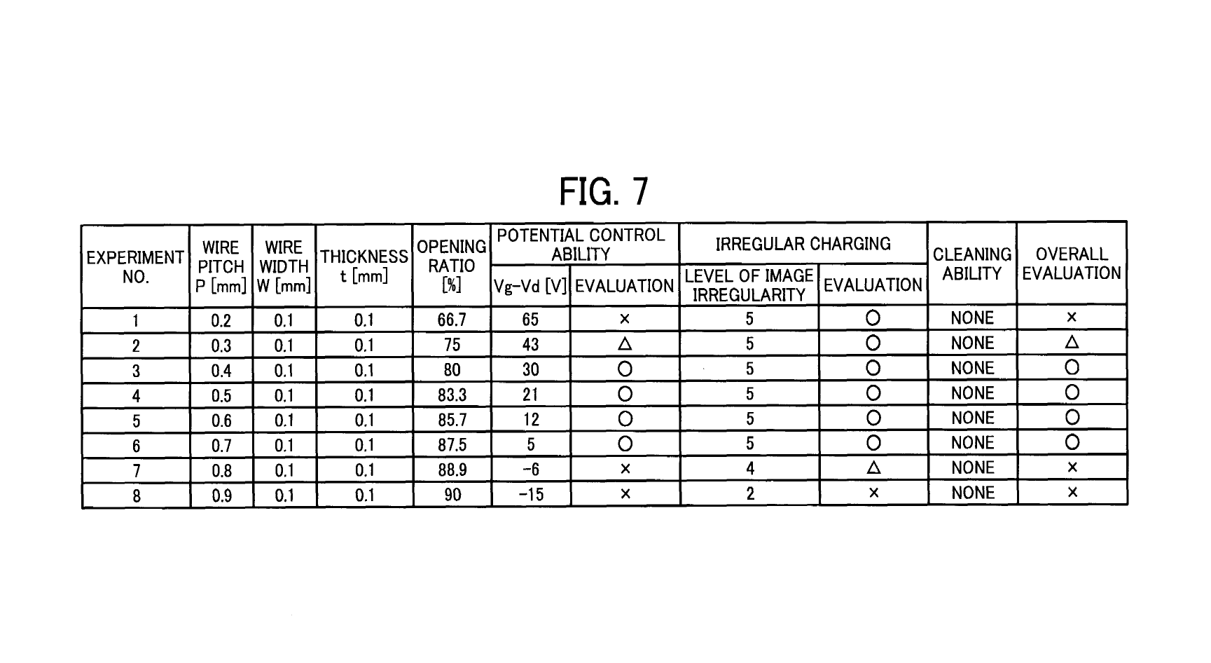

With reference to FIG. 7, results of an experiment showing the efficacy of the exemplary embodiment described above are provided. In FIG. 7, ◯ indicates that the result was good. Δ indicates that the result was not optimum, but acceptable. X indicates that the result was bad or not acceptable.

In the experiment, both the pattern wire width W and the plate thickness t of the grid electrode 23 were 0.1 mm. The pattern wire pitch P was varied by 0.1 mm through a range from 0.2 mm to 0.9 mm. The following performances were evaluated: Potential control; irregular charging and potential control; and cleaning ability, in which irregular cleaning and cleaning failure were evaluated.

Potential control was calculated as follows:

Vg−Vd [V],

where Vg is the potential of the grid electrode and Vd is the potential of the photoreceptor. Irregular image concentration per 1-dot image after 10,000 prints was measured and categorized into 5 different levels to evaluate irregular charging and potential control. Irregular cleaning and cleaning failure were measured to examine cleaning performance. The results indicated that, when Vg−Vd is less than or equal to 40 [V], the efficiency of the scorotron charger was optimized. A detailed discussion of the experiments follows.

[Potential Control]

When the opening ratio was increased, the potential difference between the potential of the grid electrode Vg and the potential of the photoreceptor Vd decreased. When the opening ratio was 80%, the potential difference was 30 V. When the opening ratio exceeded 87.5%, the potential of the photoreceptor Vd was higher than the potential of the grid electrode Vg. When the opening ratio exceeded 87.5%, control of the grid electrode 23 deteriorated.

[Irregular Charging]

Irregular image concentration per 1-dot image after 10,000 prints was measured and categorized into 5 different levels to evaluate the irregular charging and potential control. At Level 5, no visual evidence of irregular image concentration was found. At Level 4, a slight but insignificant irregular image concentration was visible in a portion of the image. At Level 3, irregular image concentration was visible in a portion of the image. At Level 2, significant irregular image concentration was visible in a portion of the image. At Level 1, significant irregular image concentration was visible in the entire area.

After 10,000 prints the grid electrode 23 and the charge wire 21 were contaminated with toner and/or other contaminants to such an extent that the corona discharge became unstable. Consequently, a plurality of bright spots was generated on the charge wire 21. When control of the grid electrode 23 was not good, the surface of the photoreceptor was not evenly charged. This irregular charging caused significant irregular image concentration on the 1-dot image, for example. As noted above, when the opening ratio exceeded 87.5%, control of the grid electrode 23 deteriorated, and the level of the irregular image concentration on the 1-dot image deteriorated.

[Cleaning Ability]

After 10,000 prints were made and the cleaning unit 24 was activated, irregular cleaning and/or cleaning failure did not occur under any circumstances. Therefore, when the opening ratio of the grid electrode 23 was configured to be in a range from 80% to 87.5%, a scorotron charger was able to be optimized.

It should be noted that elements and/or features of different exemplary embodiments may be combined with each other and/or substituted for each other within the scope of this disclosure and appended claims.

For example, the number of constituent elements, locations, shapes and so forth of the constituent elements are not limited to any of the structure for performing the methodology illustrated in the drawings.

Still further, any one of the above-described and other exemplary features of the present invention may be embodied in the form of an apparatus, method, system, computer program and computer program product. For example, any of the aforementioned methods may be embodied in the form of a system or device, including, but not limited to, any of the structure for performing the methodology illustrated in the drawings.

Example embodiments being thus described, it will be obvious that the same may be varied in many ways. Such exemplary variations are not to be regarded as a departure from the spirit and scope of the present invention, and all such modifications as would be obvious to one skilled in the art are intended to be included within the scope of the following claims.

What is claimed is:

1. A grid electrode disposed across from a charge wire, the grid electrode comprising:
a planar member including a plurality of adjacent aligned openings, each having a long side and a short side; and
a plurality of linear pattern wires in the planar member extending in a long direction of the openings, and evenly spaced in a short direction of the openings.

2. The grid electrode according to claim 1, wherein an opening ratio expressed by {P/(P+W)}×100 is in a range of from 80% and 87.5%, where W is a wire width of the pattern wire in the short direction and P is a wire pitch.

3. The grid electrode according to claim 2, wherein a relation t≦W is satisfied, where t is a thickness of the planar member.

4. A process cartridge detachable from an image forming apparatus, comprising:
an image carrier including a surface to bear a toner image; and
a scorotron charger configured to charge the image carrier,
the scorotron charger including
a shield case;
a charge wire tensioned in a long direction of the shield case; and
a grid electrode,
the grid electrode including
a planar member including a plurality of adjacent aligned openings, each having a long side and a short side, and
a plurality of linear pattern wires in the planar member extending in a long direction of the openings, and evenly spaced in a short direction,
wherein the scorotron charger is integrally provided with a photoreceptor.

5. The process cartridge according to claim 4, wherein the scorotron charger further includes a cleaner configured to clean the grid electrode while traveling in the long direction of the grid electrode.

6. The process cartridge according to claim 4, wherein an opening ratio of the grid electrode expressed by {P/(P+W)}×100 is in a range of from 80% and 87.5%, where W is a wire width of the pattern wire in the short direction and P is a wire pitch.

7. The process cartridge according to claim 6, wherein the grid electrode satisfies a relation t≦W, where t is a thickness of the planar member.

8. An image forming apparatus, comprising:
an image carrier to bear a toner image;
an exposure unit configured to irradiate a surface of the image carrier so as to form an electrostatic latent image thereon;
a developing unit configured to develop the electrostatic latent image on the surface of the image carrier so as to form a visible image;
a transfer unit configured to transfer the visible image onto a recording medium through an intermediate transfer medium; and
a scorotron charger configured to charge the image carrier, the scorotron charger including
a shield case,
a charge wire tensioned in a long direction of the shield case, and
a grid electrode,
the grid electrode including
a planar member including a plurality of adjacent aligned openings, each having a long side and a short side, and
a plurality of linear pattern wires in the planar member extending in the long direction of the openings and evenly spaced in the short direction.

9. The image forming apparatus according to claim 8, wherein the scorotron charger further includes a cleaner configured to clean the grid electrode while traveling in the long direction of the grid electrode.

10. The image forming apparatus according to claim 8, wherein an opening ratio of the grid electrode expressed by {P/(P+W)}×100 is in a range of from 80% and 87.5%, where W is a wire width of the pattern wire in the short direction and P is a wire pitch.

11. The image forming apparatus according to claim 10, wherein the grid electrode satisfies a relation t≦W, where t is a thickness of the planar member.
